(19) United States
(12) Patent Application Publication
(10) Pub. No.: US 2017/0234337 A1
(43) Pub. Date: Aug. 17, 2017

(54) AMPLIFYING THE RESPONSE OF SOFT FLUIDIC ACTUATORS BY HARNESSING SNAP-THROUGH INSTABILITIES

(71) Applicant: President and Fellows of Harvard College, Cambridge, MA (US)

(72) Inventors: Katia Bertoldi, Somerville, MA (US); Johannes T.B. Overvelde, Den Haag (NL); Tamara Kloek, Delft (NL)

(21) Appl. No.: 15/043,104

(22) Filed: Feb. 12, 2016

(51) Int. Cl. F15B 15/10

(52) U.S. Cl. CPC F15B 15/10

(57) ABSTRACT

In at least some aspects, there is provided a fluidic actuator including at least one fluidic actuator segment that includes an elastic tube, having a first initial length, and a braid, having a second initial length greater than the first initial length. The braid is disposed, in a buckled state, about the elastic tube and imparts an axial force to the elastic tube.

### STATEMENT REGARDING FEDERALLY SPONSORED RESEARCH

Some aspects of this present disclosure were made with government support, under NSF Grant Nos. DMR-1420570 and CMMI-1149456 awarded by the National Science Foundation, and the government shares rights to such aspects of the present disclosure.

### FIELD OF THE INVENTION

The present invention relates generally to actuators, particularly soft actuators.

### BACKGROUND OF THE INVENTION

The ability of elastomeric materials to undergo large deformation has recently enabled the design of actuators that are inexpensive, easy to fabricate, and only require a single source of pressure for their actuation, and still achieve complex motion. These unique characteristics have allowed for a variety of innovative applications in areas as diverse as medical devices, search and rescue systems, and adaptive robots. However, existing fluidic soft actuators typically show a continuous, quasi-monotonic relation between input and output, so they rely on large amounts of fluid to generate large deformations or exert high forces.

### SUMMARY OF THE INVENTION

The present concepts introduce a class of soft actuators, comprising one or more fluidic actuator segments, which harness snap-through instabilities to at least substantially instantaneously trigger large changes in internal pressure, extension, shape, and exerted force. The present concepts, described herein in relation to both experimental data and numerical tools, present an approach that enables the design of customizable fluidic actuators for which a small increment in supplied volume (input) is sufficient to trigger large deformations or high forces (output).

According to one aspect of the present concepts, a fluidic actuator comprises at least one fluidic actuator segment comprising an elastic tube having a first initial length and a braid having a second initial length greater than the first initial length disposed, in a buckled state, about the elastic tube and imparting an axial force to the elastic tube.

According to another aspect of the present concepts, a method of making a fluidic actuator comprises the act of selecting a plurality of fluidic actuator segments, each of the plurality of fluidic actuator segments comprising an elastic tube having a first initial length and a braid having a second initial length greater than the first initial length disposed, in a buckled state, about the elastic tube and imparting an axial force to the elastic tube. The method also includes the act of interconnecting the plurality of fluidic actuator segments to allow fluid flow there between. The act of selecting also includes selecting the plurality of fluidic actuator segments to trigger one or more snap-through instabilities responsive to predetermined volumetric fluid inputs to release energy and trigger at least substantially instantaneous changes in at least one of internal pressure, extension, shape, and exerted force.

In yet other aspects of the present concepts, a fluidic actuator system includes at least one fluidic actuator comprising at least one fluidic actuator segment, the at least one fluidic actuator segment comprising an elastic tube having a first initial length and a braid having a second initial length greater than the first initial length disposed, in a buckled state, about the elastic tube and imparting an axial force to the elastic tube. The fluidic actuator system also includes a fluid reservoir, a valve disposed in a fluid pathway between the fluid reservoir and the at least one fluidic actuator, and a controller configured to actuate the valve to effectuate an introduction of a pre-determined volume of a fluid from the fluid reservoir into the at least one fluidic actuator to effect a state change in the at least one fluidic actuator from a first state to a second state or to effectuate a discharge of a pre-determined volume of a fluid from the at least one fluidic actuator to effect a state change in the at least one fluidic actuator from a second state to a first state.

Additional aspects of the present concept will be apparent to those of ordinary skill in the art in view of the detailed description of various embodiments, which is made with reference to the drawings, a brief description of which is provided below.

### BRIEF DESCRIPTION OF THE DRAWINGS

FIGS. 1A-1F show some aspects of the present concepts wherein, in FIGS. 1A-1C, components of a fluidic soft actuator segment (“fluidic actuator segment”) comprising a stiff braid and a latex tube creating, in combination, a fluidic actuator segment with a highly nonlinear response and, in FIGS. 1D-1F, images of a fluidic actuator segment in operation (during inflation).

FIGS. 1G-1H show pressure (p) versus volume (v) plots and length (l) versus volume (v) plots, respectively, for 36 different fluidic actuator segments corresponding to those shown in FIGS. 1A-1F at v=0, 10, 20 mL (Scale bars: 10 mm.).

FIGS. 2A-2B shows evolution of pressure (p) and length (l) as a function of the supplied volume (v) for two different fluidic actuator segments with images of the fluidic actuator segments at v=0, 10, 20 (left) and v=0, 12, 24 mL (right), respectively.

FIG. 2C shows two fluidic actuator segments of FIGS. 2A-2B connected to form a new, multi-segment fluidic soft actuator (“multi-segment fluidic actuator”) in accord with at least some aspects of the present concepts.

FIGS. 2D-2J shows, for the multi-segment fluidic actuator of FIG. 2C, evolution of pressure (p) and length (l) as a function of the supplied volume (v) FIG. 2D) and images of the multi-segment fluidic actuator at v=0, 9, 18, 27, 36 and 45 mL (FIGS. 2E-2J).

FIGS. 3A-3B show, respectively, the experimentally measured pressure-volume and length-volume relations from FIGS. 1G-1H, with emphasis on two segments used to demonstrate the numerical algorithm disclosed herein.

FIG. 3C shows numerically determined elastic energy, E, for a multi-segment fluidic actuator comprising the two segments whose individual behavior is highlighted in FIGS. 3A-3B, with energy being shown for increasing values of the supplied volume, v.

FIG. 3D shows equilibrium configurations for the multi-segment fluidic actuator of FIGS. 3A-3B, indicating, at v=19 mL, an unstable (1, 1) transition, resulting in a significant internal volume flow, and a second instability of type (1, 2) being triggered at v=22 mL.

FIG. 3E shows numerically determined pressure-volume and length-volume relations for the combined soft actuator of FIGS. 3A-3B.

FIGS. 4A-4C are, respectively, Δ\hat{v}, Δ\hat{l} and Δ\hat{p} versus the normalized change in energy ΔÊ for all state transitions that occur in 630 multi-segment fluidic actuators having n=2 segments (combinations of the 36 segments from FIGS. 1C-1D).

FIGS. 5A-5B show experimental (solid lines) and numerical (dashed lines) pressure-volume curves for two multi-segment fluidic actuators comprising n=2 segments, with the transitions for the actuator of FIG. 5A being shown by diamond markers in FIG. 4 and with the transitions for the actuator of FIG. 5B being shown by square markers in FIG. 4, and with the top illustrations in FIGS. 5A-5B showing various phases of the multi-segment fluidic actuators before and after each state transition (at v=4, 26 mL for FIG. 5A and at v=5, 16, 24 mL for FIG. 5B).

FIGS. 5C-5D show experimentally measured exerted force (f) as a function of the supplied volume (v) for multi-segment fluidic actuators having L_{braid}, L_{tube}=(48, 30) and (50, 20) mm (FIG. 5C) and (L_{braid}, L_{tube})=(44, 30) and (48, 26) mm (FIG. 5D) with constrained ends.

FIGS. 6A-6D are depictions of a multi-segment fluidic actuator (n=3) with (L_{braid}, L_{tube})=(40,28), (44, 30), and (50, 24) mm in a first state (top) and a second state (bottom), wherein the second state represents inflation of the multi-segment fluidic actuator to v=28 mL, decoupling from the syringe pump, and connection to a small reservoir containing only 1 mL of water, with an additional volume of 1 mL supplied to the system being enough to trigger a significant internal volume flow of ˜20 mL resulting in the deflation of two segments into one segment.

FIGS. 7A-7D shows (left) depictions of a tube characterized by L_{tube}=22 mm at v=0, 20, 40 mL (Scale bar: 10 mm) and (right) evolution of pressure (p) as a function of the supplied volume (v) for three latex tubes characterized by L_{tube}=22, 26, and 30 mm as measured in experiments (solid lines) and predicted by the analytical model (dashed lines).

FIGS. 8A-8D show a numerical procedure to determine the equilibrium configurations for a multi-segment fluidic actuator with n=2 wherein FIGS. 8A-8B shows identification of the volumes of each segment that correspond to a given value of pressure (in this case pₚₒᵢₙₜ), FIG. 8C shows all corresponding equilibrium configurations for the multi-segment fluidic actuator by combining all those volumes, and FIG. 8D shows that, because v=v₁+v₂, all equilibrium points in the pressure-volume curve for the multi-segment fluidic actuator can be identified.

FIGS. 9A-9B show numerical results for two multi-segment fluidic actuators with n=2, with FIG. 9A showing a relation between the individual volumes of the segments for multi-segment fluidic actuator with (L_{braid}, L_{tube})=(48, 30) and (50, 20) mm and FIG. 9B showing a relation between the individual volumes of the segments for a multi-segment fluidic actuator with (L_{braid}, L_{tube})=(44, 30) and (48, 26) mm.

FIGS. 10A-10C show Δ\hat{v}, Δ\hat{l} and Δ\hat{p} versus the normalized change in energy ΔÊ for all state transitions that occur in 7,140 multi-segment fluidic actuators comprising n=3 fluidic actuator segments.

FIG. 10D shows experimental (solid line) and numerical (dashed line) evolution of pressure and length as a function of the supplied volume for a multi-segment fluidic actuator with n=3, characterized by (L_{braid}, L_{tube})=(40, 28), (44, 22), and (48, 26) mm.

FIG. 10E shows a numerically determined relation between the individual volumes of the three segments.

FIGS. 11A-11F shows examples of multi-segment fluidic actuators in accord with at least some aspects of the present concepts and associated actuation times.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

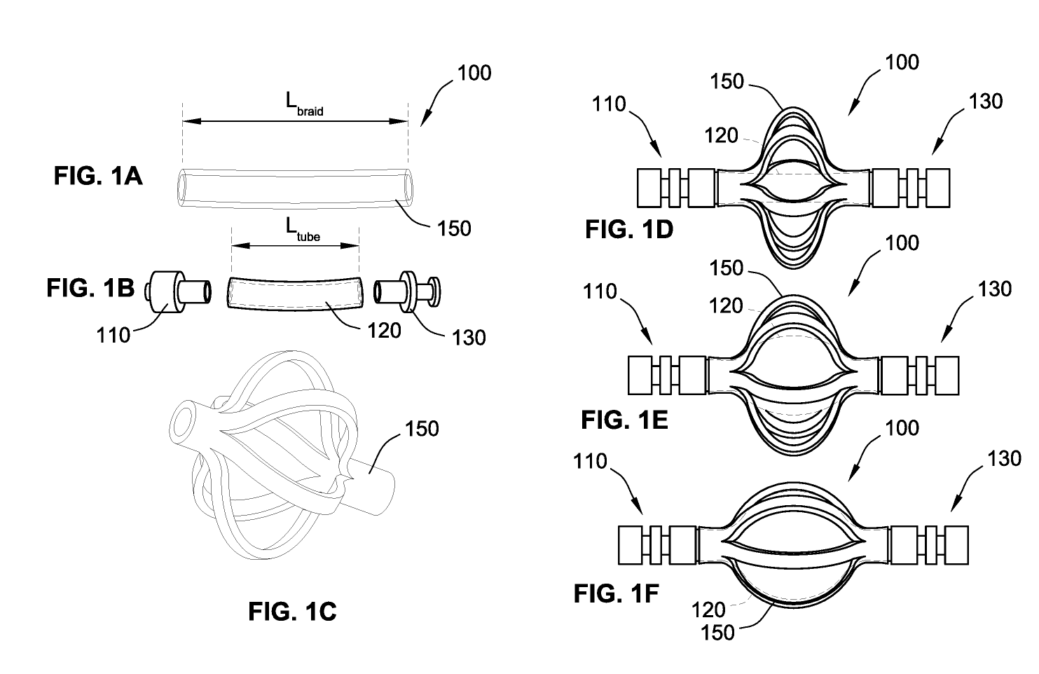

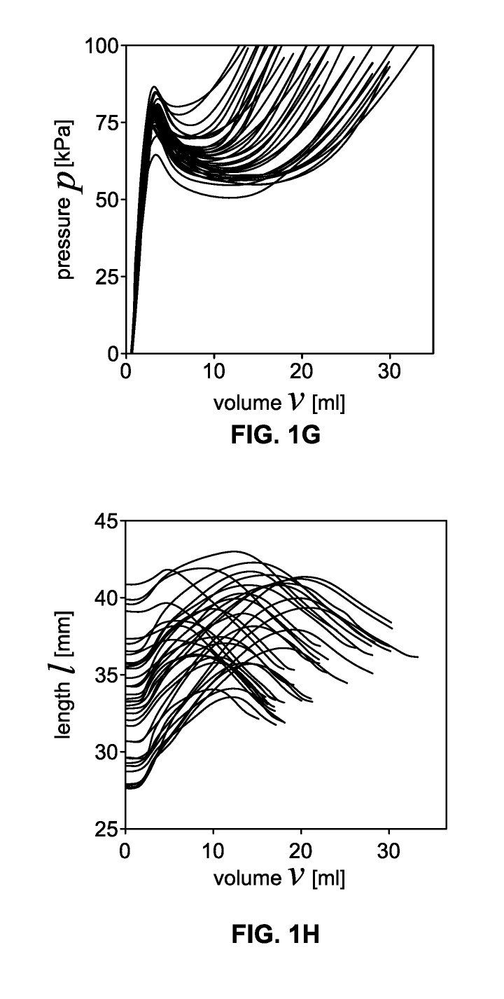

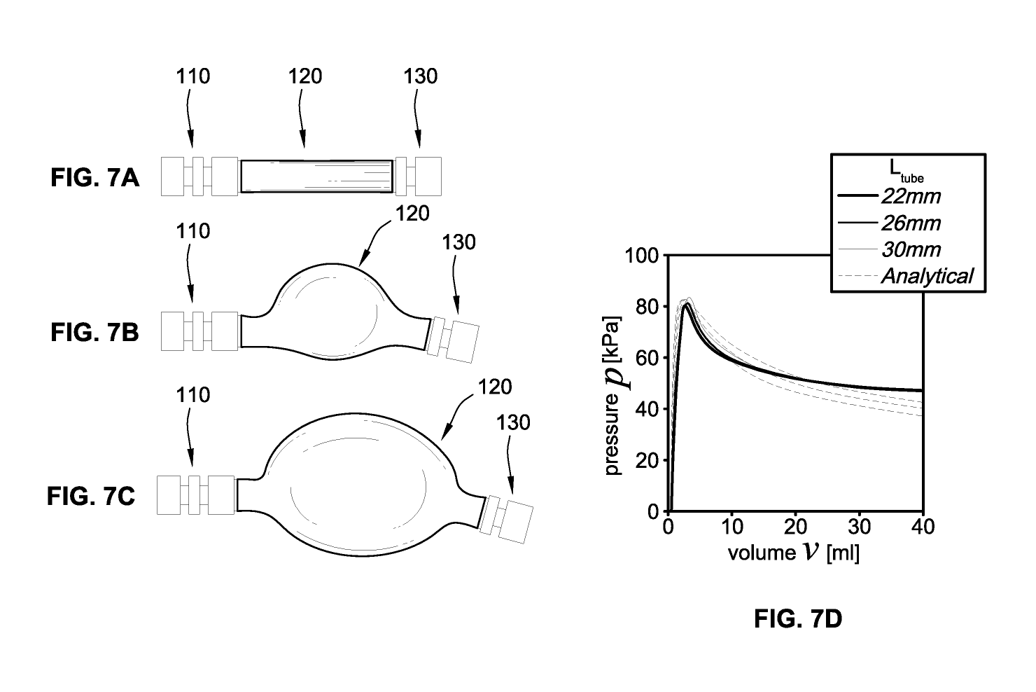

To experimentally realize inflatable segments characterized by a nonlinear pressure-volume relation, the inventors initially fabricated fluidic actuator segments consisting of a soft latex tube 120 (see FIGS. 7A-7D, see also FIGS. 1A-1C) of initial length L_{tube}, inner radius R=6.35 mm, and thickness H=0.79 mm. The pressure-volume relation was measured experimentally for three segments with L_{tube}=22-30 mm, wherein a left connector 110 comprised a stopper or plug and the right connector 130 was open to receive input fluid, and it was determined that their response was not affected by their length. FIGS. 7A-7D shows (left) depictions of a tube characterized by L_{tube}=22 mm at v=0, 20, 40 mL (Scale bar: 10 mm) and (right) evolution of pressure (p) as a function of the supplied volume (v) for three latex tubes characterized by L_{tube}=22, 26, and 30 mm as measured in experiments (solid lines) and predicted by the analytical model (dashed lines). The response does not show a final steep increase in pressure due to the almost linear behavior of latex, even at large strains.

Following the experiment in FIGS. 7A-7D, the inventors constructed fluidic actuator segments 100 with a final steep increase in pressure and a tunable and controllable response, enclosing the latex tube 120 by longer and stiffer braids 150 of length L_{braid} (see FIGS. 1A-1C). The effect of the stiff braids 150 is twofold. First, as L_{braid}>L_{tube}, the braids are in a buckled state when connected to the latex tube 120 (FIGS. 1D-1F), and therefore apply an axial force, F, to the membrane. Second, at a certain point during inflation when the membrane and the braids come into contact, the overall response of the segments stiffens.

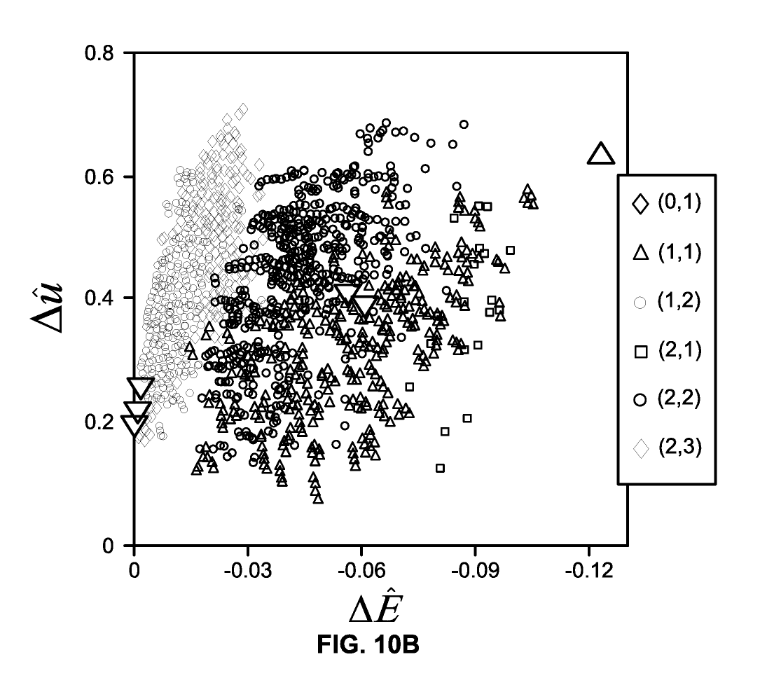

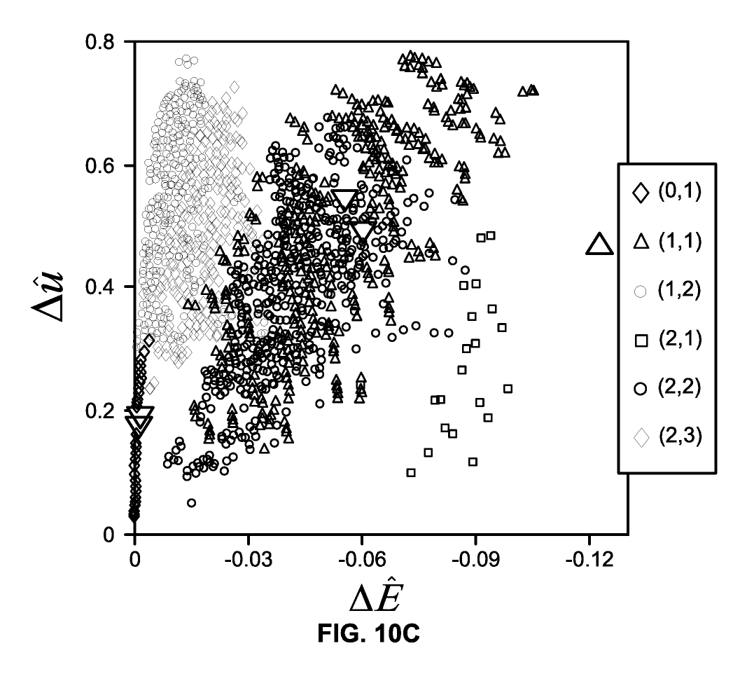

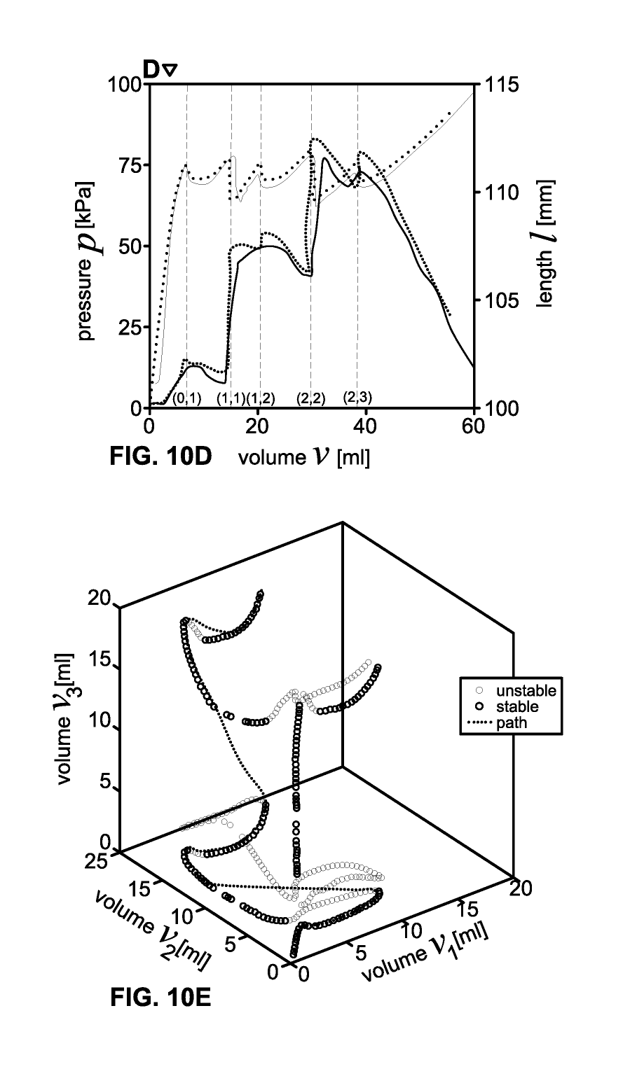

A simple analytical model was developed to predict the effect of L_{braid} and L_{tube} on the nonlinear response of these braided fluidic actuator segments 100 (see infra, Eq. [S14]-[S46] and corresponding text). It is interesting to note that the analysis indicates that, for a latex tube 120 of given length, shorter braids 150 lower the peak pressure due to larger axial forces (see FIGS. 10C and 10E). Moreover, it also shows that L_{braid} strongly affects the volume at which stiffening occurs. In fact, it was determined that the shorter the braids 150, the earlier contact between the braids and the membrane 120 occurs, reducing the amount of supplied volume required to have a steep increase in pressure. Conversely, if L_{braid} is fixed, and the length of the membrane 120 is varied, both the pressure peak and the volume at which stiffening occurs remain unaltered (see FIG. 10F). However, in this case it was found that shorter tubes 120 lower the pressure of the softening region. Finally, the analytical model also indicates that the length of the fluidic actuator segments 100, l=λ_{z}L_{tube}, initially increases upon inflation (FIGS. 10E-10F). However, when the tube 120 and braids 150 come into contact, further elongation is restrained by the braids and the segments 100 shorten as a function of the supplied volume.

Having demonstrated analytically that fluidic actuator segments 100 with the desired nonlinear response can be constructed by enclosing a latex tube 120 by longer and stiffer braids 150, and that their response can be controlled by changing L_{braid} and L_{tube}, actuators were fabricated. The stiffer braids 150 were made from polyethylene-lined ethyl vinyl acetate tubing, with an inner radius of 7.94 mm and a thickness of 1.59 mm. Eight braids 150 were formed by partly cutting this outer tube along its length guided by a 3D printed socket. Finally, Nylon Luer lock couplings (one socket 130 and one plug 110) were glued to both ends of the fluidic actuator segments 100 to enable easy connection (see FIGS. 1A-1C, FIGS. 7A-7D). The responses of the actuators 100 were experimentally determined by inflating them with water at a rate of 60 mL/min, ensuring quasi-static conditions (see FIGS. 1D-1F).

Then, 36 fluidic actuator segments 100 were fabricated with L_{braid}=40-50 mm and L_{tube}=20-30 mm. As shown in FIG. 1G, all fluidic actuator segments 100 were characterized by the desired nonlinear pressure-volume relation and followed the trends predicted by the analytical model (see FIGS. 10E-10F). In particular, it was found that, for the 36 tested fluidic actuator segments 100, the initial peak in pressure ranged between 65 and 85 kPa (see FIG. 1G). The length of the fluidic actuator segments 100 was monitored during inflation (see FIG. 1H). As predicted by the analytical model, it was found that initially the fluidic actuator segments 100 elongate, but then shorten when the tube 120 and braids 150 come into contact. It is important to note that no instabilities are triggered upon inflation of the individual fluidic actuator segments 100, because the supplied volume is controlled, not the pressure.

In general, the present concepts include interconnection of any number of fluidic actuator segments 100 (i.e., 100a, 100b . . . 100n, where n is any integer), via selection of appropriate mechanical connection elements 110, 130, to form a multi-segment fluidic soft actuator (“multi-segment fluidic actuator”) tailored to provide a specific response to a specific input (e.g., a specific pressure response to a specific volume change, etc.). Alternatively, rather than being formed by a plurality of separate disparate fluidic actuator segments 100 (i.e., 100a, 100b . . . 100n, where n is any integer), a multi-segment fluidic actuator may be formed as a unitary member, with fluidic actuator segments being defined therein. The multi-segment fluidic actuator is constructed, or formed, via selection of appropriate mechanical connection elements 110, 130, together with selected braid 150 and tube 120 materials and parameters, to form a multi-segment fluidic soft actuator (“multi-segment fluidic actuator”) tailored to provide a specific response to a specific input (e.g., a specific pressure response to a specific volume change, etc.).

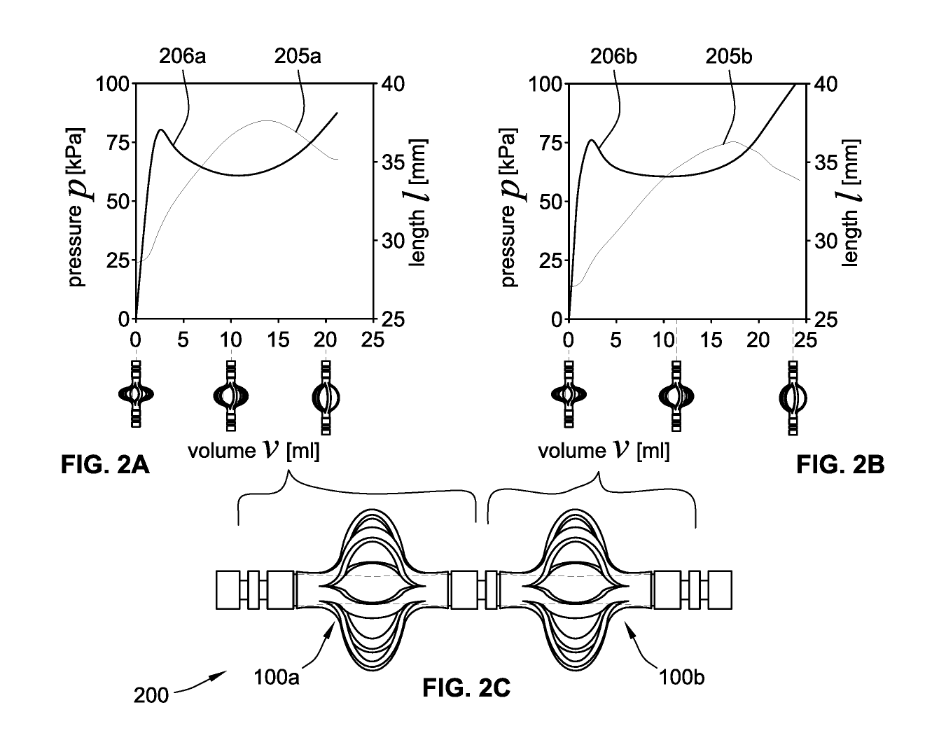

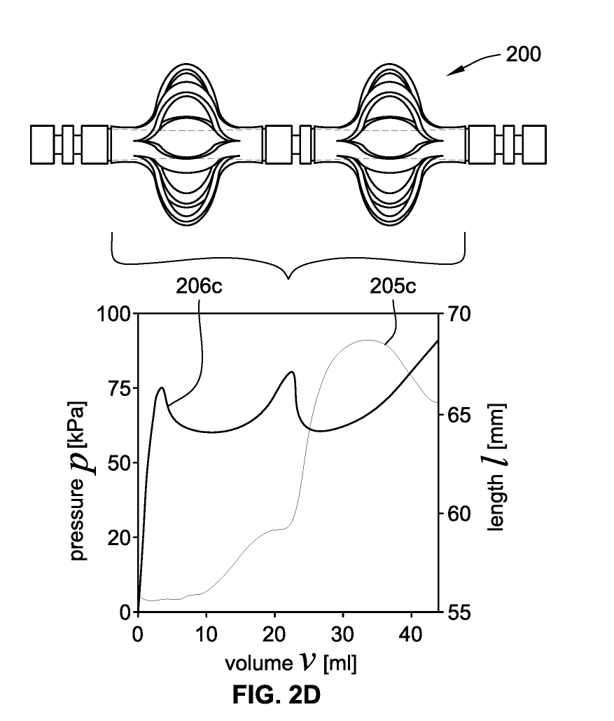

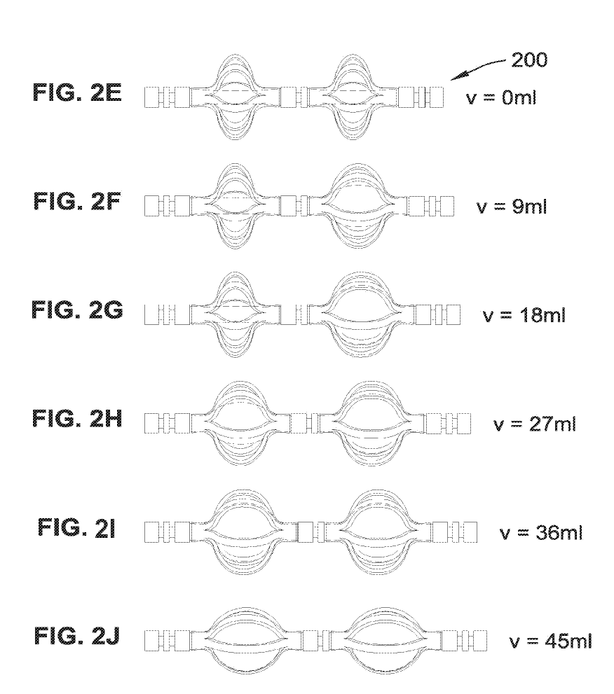

Following the above experiments, the inventors created a multi-segment fluidic actuator 200 by interconnecting the two segments 100a, 100b whose individual responses are shown in FIGS. 2A-2B. This multi-segment fluidic actuator 200 is shown in FIG. 2C as the interconnected fluidic actuator segments 100a, 100b. FIG. 2D shows, for the multi-segment fluidic actuator 200 of FIG. 2C, evolution of pressure (p) and length (l) as a function of the supplied volume (v) and FIGS. 2E-2J show depictions of the multi-segment fluidic actuator 200 at v=0, 9, 18, 27, 36 and 45 mL.

Upon inflation of this multi-segment fluidic actuator 200, very rich behavior emerges (see FIG. 2D). In fact, the pressure-volume response of the multi-segment fluidic actuator is not only characterized by two peaks, but the second peak is also accompanied by a significant and instantaneous elongation. This suggests that an instability at constant volume was triggered.

To better understand the behavior of such multi-segment fluidic actuators 200, the inventors developed a numerical algorithm that accurately predicts the response of systems containing n segments, based solely on the experimental pressure-volume curves of the individual segments. By using the 36 fluidic actuator segments 100 from experiments as building blocks, the inventors constructed 36!/[(36-n)!n!] multi-segment fluidic actuators 200 comprising n segments (i.e., 630 different multi-segment fluidic actuators for n=2; 7,140 for n=3; and 58,905 for n=4), where it was assumed that the order in which the segments are arranged did not matter. It is therefore crucial to implement a robust algorithm to efficiently scan the range of responses that can be achieved.

It is to be noted that, upon inflation, the state of the ith fluidic actuator segment 100 is defined by its pressure pᵢ and volume vᵢ, and its stored elastic energy can be calculated as

$${E}_{i} ( {v}_{i} ) = {\int }_{{V}_{i}}^{{v}_{i}} {p}_{i} ( \tilde{v} ) d \tilde{v} , \qquad [ 1 ]$$

in which dynamic effects are neglected. Moreover, Vᵢ denotes the volume of the ith fluidic actuator segment 100 in the unpressurized state. When the total volume of the system, v=Σᵢ₌₁ⁿvᵢ, is controlled (as in the experiments noted herein), the response of the system is characterized by n-1 variables v₁, . . . , vₙ₋₁ and the constraint

$${v}_{n} = v - {\sum }_{i = 1}^{n - 1} {v}_{i} . \qquad [ 2 ]$$

To determine the equilibrium configurations, the elastic energy, E, stored in the system is first defined, as given by the sum of the elastic energy of the individual fluidic actuator segments 100

$$E ( {v}_{1} , … , {v}_{n} ) = {\sum }_{i = 1}^{n} {\int }_{{V}_{i}}^{{v}_{i}} {p}_{i} ( \tilde{v} ) d \tilde{v} , \qquad [ 3 ]$$

Eq. 2 is used to express the energy in terms of n-1 variables.

$$\tilde{E} ( {v}_{1} , … , {v}_{n - 1} ) = {\sum }_{i = 1}^{n - 1} {\int }_{{V}_{i}}^{{v}_{i}} {p}_{i} ( \tilde{v} ) d \tilde{v} {\int }_{{V}_{n}}^{v - {\sum }_{i = 1}^{n - 1} {v}_{i}} ( \tilde{v} ) d \tilde{v} . \qquad [ 4 ]$$

Next, a numerical algorithm is implemented to find the equilibrium path followed by the fluidic actuator segment 100 upon inflation (i.e., increasing v). Starting from the initial configuration (i.e., vᵢ=Vᵢ), the total volume of the system (v) is incrementally increased and the elastic energy (\tilde{E}) locally minimized. Because Eq. 4 already takes into account the volume constraint (Eq. 2), an unconstrained optimization algorithm is used, such as the Nelder-Mead simplex algorithm implemented in Matlab. This algorithm looks only locally for an energy minimum, similar to what happens in the experiments, and therefore it does not identify additional minima at the same volume that may appear during inflation.

Using the aforementioned algorithm, it was found that, for many fluidic actuator segments 100, the energy can suddenly decrease upon inflation, indicating that a snap-through instability at constant volume has been triggered. To fully unravel the response of the fluidic actuator segments 100, all equilibrium configurations were detected and evaluated as to stability. The equilibrium states for the system can be found by imposing

$$\frac{\partial \tilde{E}}{\partial {v}_{i}} = 0 ∀ i ∈ \{ 1 , … , n - 1 \} . \qquad [ 5 ]$$

Substitution of Eq. 4 into Eq. 5, yields

$$\frac{\partial \tilde{E}}{\partial {v}_{i}} = {p}_{i} ( {v}_{i} ) - {p}_{n} ( v - {\sum }_{j = 1}^{n - 1} {v}_{i} ) = 0 , \\ ∀ i ∈ \{ 1 , … , n - 1 \} , \qquad [ 6 ]$$

which, when substituting Eq. 2, can be rewritten as

p₁(v₁)=p₂(v₂) =. . . =pₙ(vₙ). [7]

As expected, Eq. 7 ensures that the pressure is the same in all n segments connected in series.

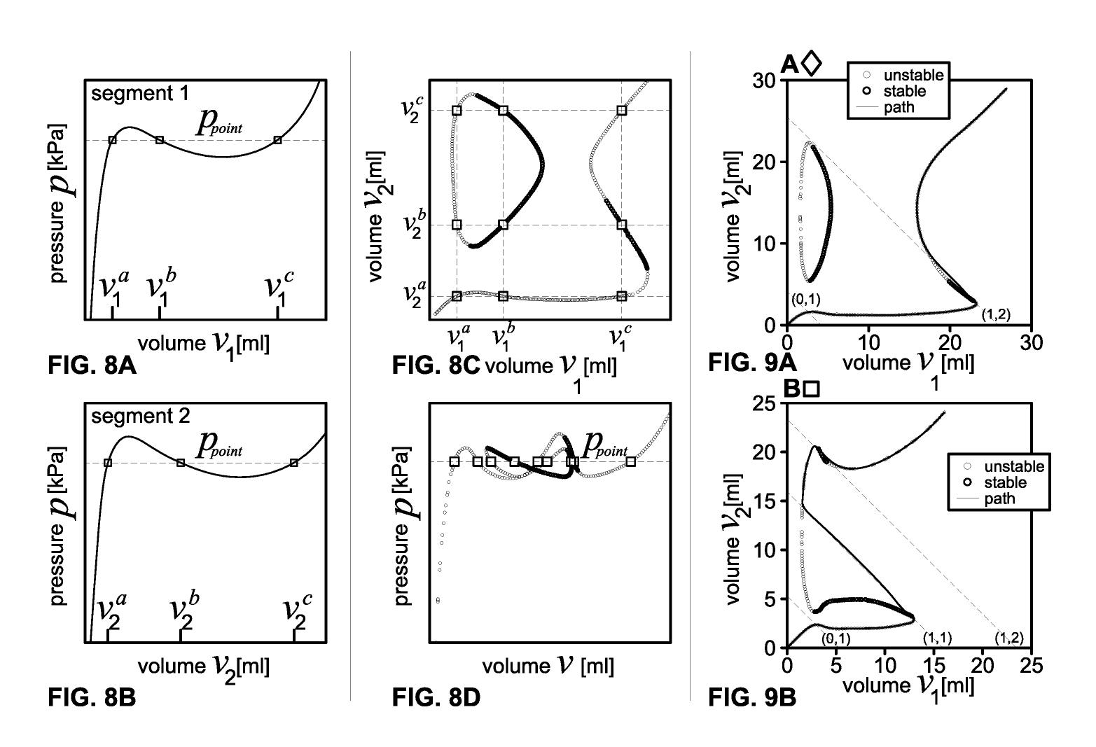

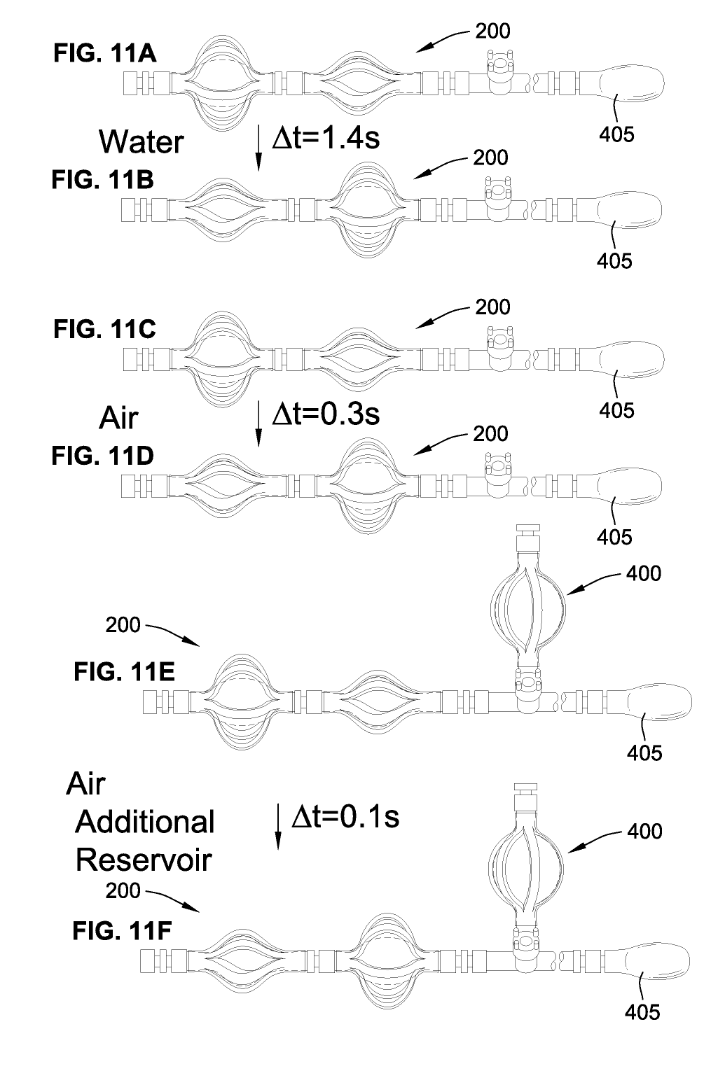

Operationally, to determine all of the equilibrium configurations of a multi-segment fluidic actuator comprising n fluidic actuator segments, first are defined 1,000 equispaced pressure points between 0 and 100 kPa. Then, for each of the n segments 100 all volumes that result in those values of pressure are found (see FIGS. 11A-11F, where the numerical procedure determines the equilibrium configurations for a multi-segment fluid actuator with n=2, identifying the volumes of each segment that correspond to a given value of pressure (in this case ppoint)). Finally, for each value of pressure, the equilibrium states are determined by making all possible combinations of those volumes (see FIG. 8C, where all corresponding equilibrium configurations are found for the multi-segment fluid actuator by combining all those volumes). Note that, by using Eq. 2, the total volume in the system at each equilibrium state can be determined and then the pressure-volume response for the multi-segment fluidic actuator 200 can be plotted (see FIG. 8D, where because v=v1+v2, all equilibrium points in the pressure-volume curve for the multi-segment fluid actuator can be identified).

Finally, the stability of each equilibrium configuration is checked. Because an equilibrium state is stable when it corresponds to a minimum of the elastic energy \tilde{E} defined in Eq. 4, at any stable equilibrium solution the Hessian matrix

$$H ( \tilde{E} ) [ {v}_{1} , … , {v}_{n - 1} ) = [ \begin{matrix}\frac{{\partial }^{2} \tilde{E}}{\partial {v}_{1}^{2}} & … & \frac{{\partial }^{2} \tilde{E}}{\partial {v}_{1} \partial {v}_{n - 1}} \\ ⋮ & ⋱ & ⋮ \\ \frac{{\partial }^{2} \tilde{E}}{\partial {v}_{n - 1} \partial {v}_{1}} & … & \frac{{\partial }^{2} \tilde{E}}{\partial {v}_{n - 1}^{2}}\end{matrix} ] \qquad [ 8 ]$$

is positive definite. The second-order partial derivatives in Eq. 8 can be evaluated as

$$\frac{{\partial }^{2} \tilde{E}}{\partial {v}_{1} \partial {v}_{j}} = \begin{matrix}{p}_{i}^{′} ( {v}_{i} ) + {p}_{n}^{′} ( v - {\sum }_{k = 1}^{n - 1} {v}_{k} ) , & if i = j \\ {p}_{n}^{′} ( v - {\sum }_{k = 1}^{n - 1} {v}_{k} ) , & if i \neq j\end{matrix} , \qquad [ 9 ]$$

in which pi′(\tilde{v})=dp/d\tilde{v}. Taking advantage of the fact that all off-diagonal terms of the Hessian matrix are identical and using Sylvester's criterion, an equilibrium state is found to be stable if

$${{∐}_{i = 1}}^{k} {p}_{i}^{′} ( {v}_{i} ) + {p}_{n}^{′} ( v - {\sum }_{k = 1}^{n - 1} {v}_{k} ) {\sum }_{i = 1}^{k} {{∐}_{j = 1 , j \neq i}}^{k} {p}_{j}^{′} ( {v}_{j} ) > 0 , \\ ∀ k = 1 , … , n - 1. \qquad [ 10 ]$$

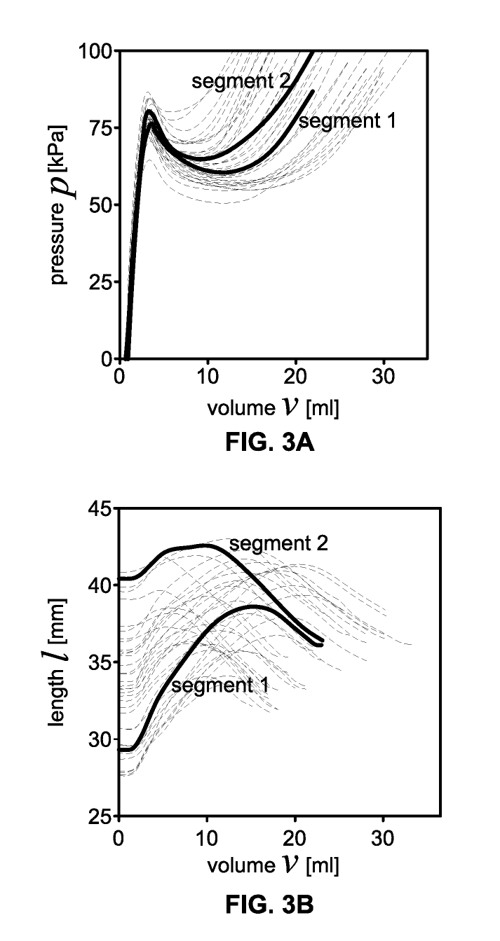

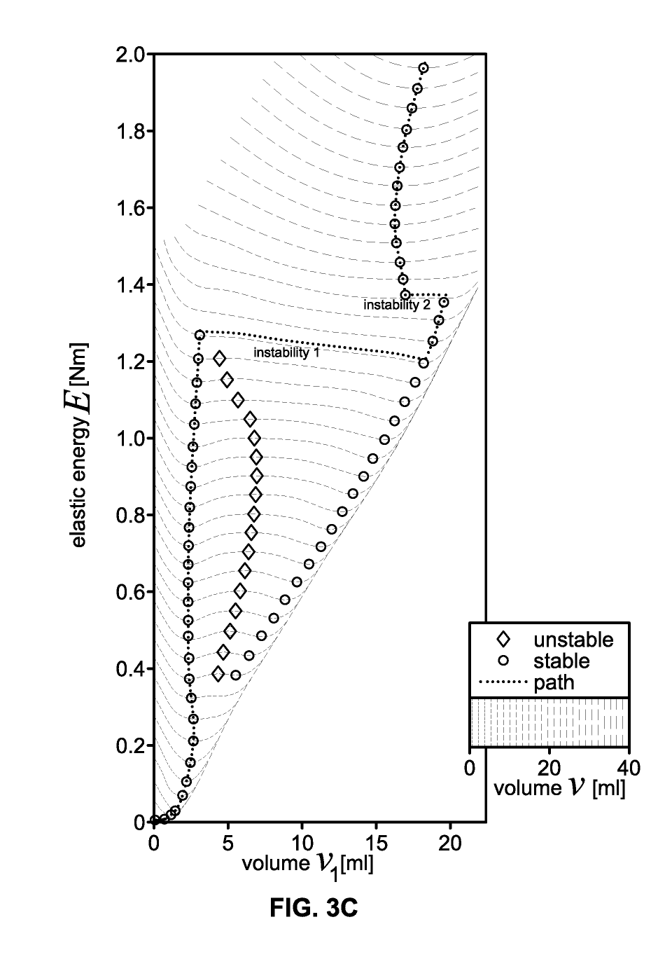

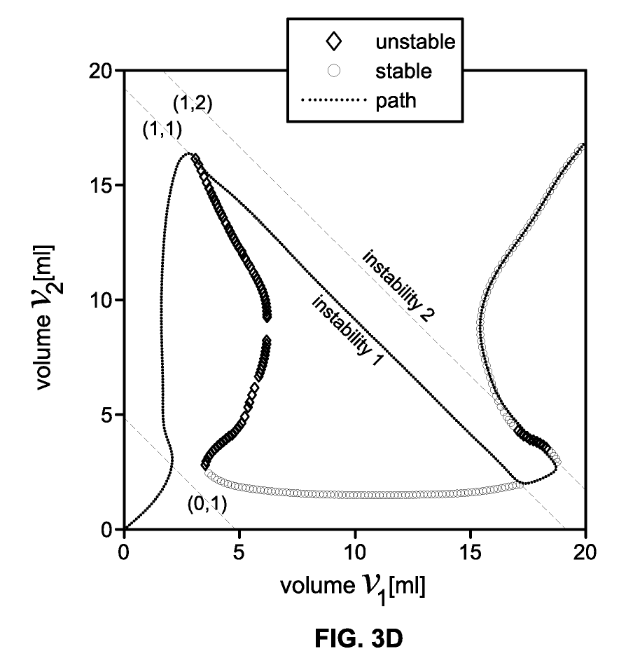

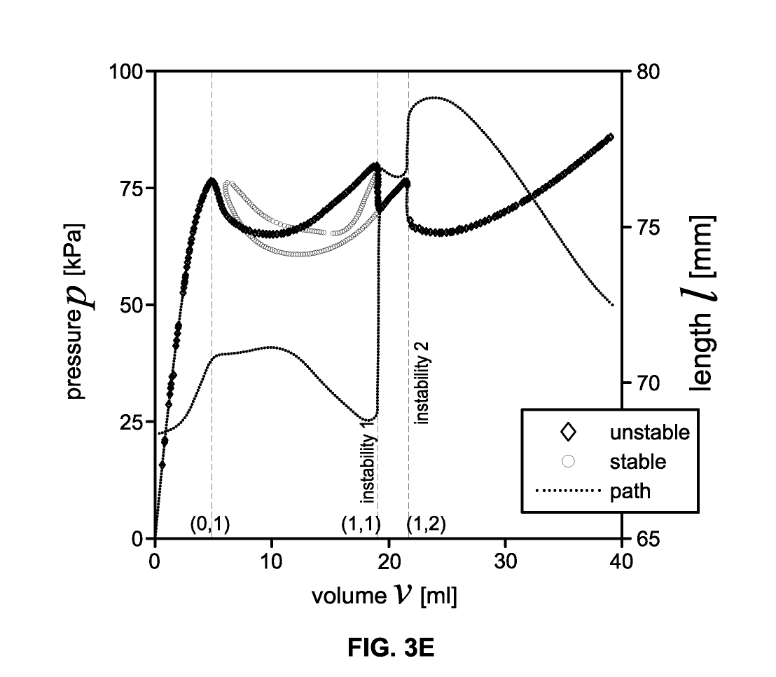

To demonstrate the numerical algorithm, two segments where the experimentally measured pressure-volume and length-volume responses are highlighted in FIGS. 3A-3B were examined. In FIG. 3C the evolution of the total elastic energy of the system, E, is reported as a function of the volume of the first fluidic actuator segment 100, v₁, for increasing values of the total supplied volume, v₁, and in FIG. 3D all equilibrium configurations in the v₁-v₂ plane are shown. It was found that, initially (0<v<5 mL), the volume of both fluidic actuator segments 100 increased gradually. However, for 5<v<19 mL, v₁ remains almost constant and all additional volume that is added to the system flows into the second fluidic actuator segment. Moreover, at v=6 mL a second local minimum for E emerges, so that for 6<v<19 mL the system is characterized by two stable equilibrium configurations. Although for v>13 mL this second minimum has the lowest energy, the system remains in the original energy valley until v=19 mL. At this point the local minimum of E in which the system is residing disappears, so that its equilibrium configuration becomes unstable, forcing the fluidic actuator segment 100 to snap to the second equilibrium characterized by a lower value of E. Interestingly, this instability triggers a significant internal volume flow from the second to the first fluidic actuator segment (see FIG. 3D) and a sudden increase in length (see FIG. 3E). Further inflating the system to v=22 mL triggers a second instability, at which some volume suddenly flows back from the first fluidic actuator segment to the second fluidic actuator segment. After this second instability, increasing the system's volume further inflates both segments simultaneously.

All transitions that take place upon inflation (i.e., at v=5, 19, and 22 mL) are highlighted by a peak in the pressure-volume curve (see FIG. 3E), and correspond to instances at which one or more of the individual fluidic actuator segments 100 cross their own peak in pressure. These state transitions can either be stable or unstable (FIGS. 3C-3E). A stable transition always leads to an increase of the elastic energy stored in the system, and an instability results in a new equilibrium configuration with lower energy. Each state transition can therefore be characterized by the elastic energy release, which are defined as a normalized scalar Δ\tilde{E}=(Eₚₒₛₜ-Eₚᵣₑ)/Eₚᵣₑ. It is to be noted that hereinafter, the subscripts “pre” and “post” indicate, respectively, the values of the quantity immediately before and after the state transition. Moreover, to better understand the effects of each transition on the system, the associated normalized changes in internal volume distribution, length and pressure were defined as Δ\tilde{v}=max(v_{i,post}-v_{i,pre})/vₚᵣₑ, Δ\tilde{l}=(lₚₒₛₜ-lₚᵣₑ)/(lₚᵣₑ) and Δ\tilde{p}=(pₚₒₛₜ-pₚᵣₑ)/pₚᵣₑ.

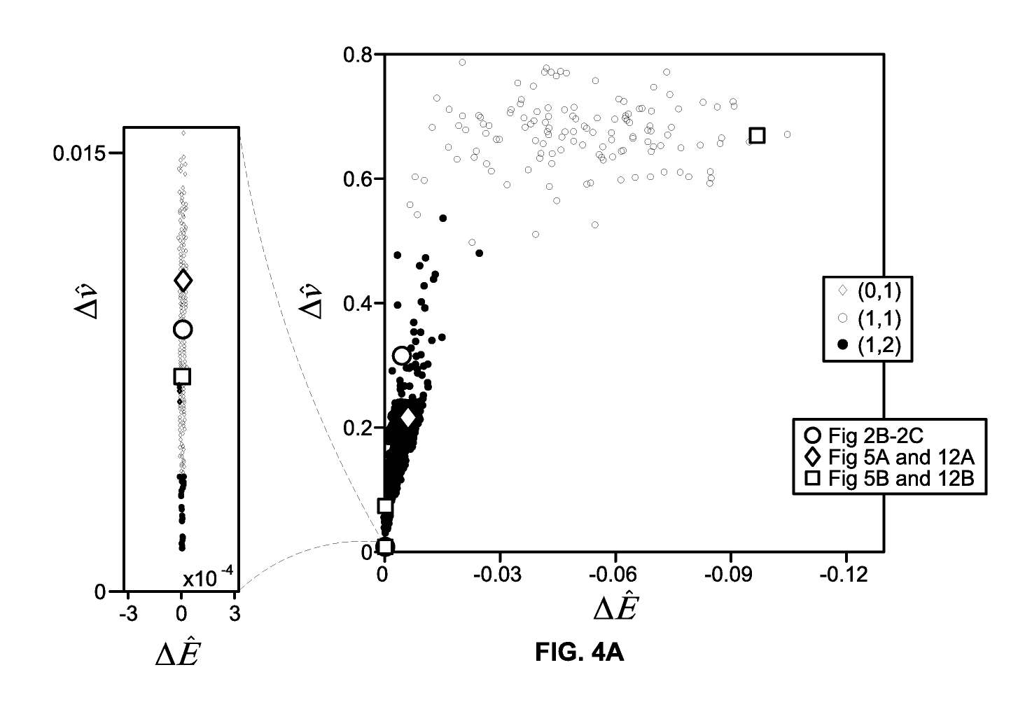

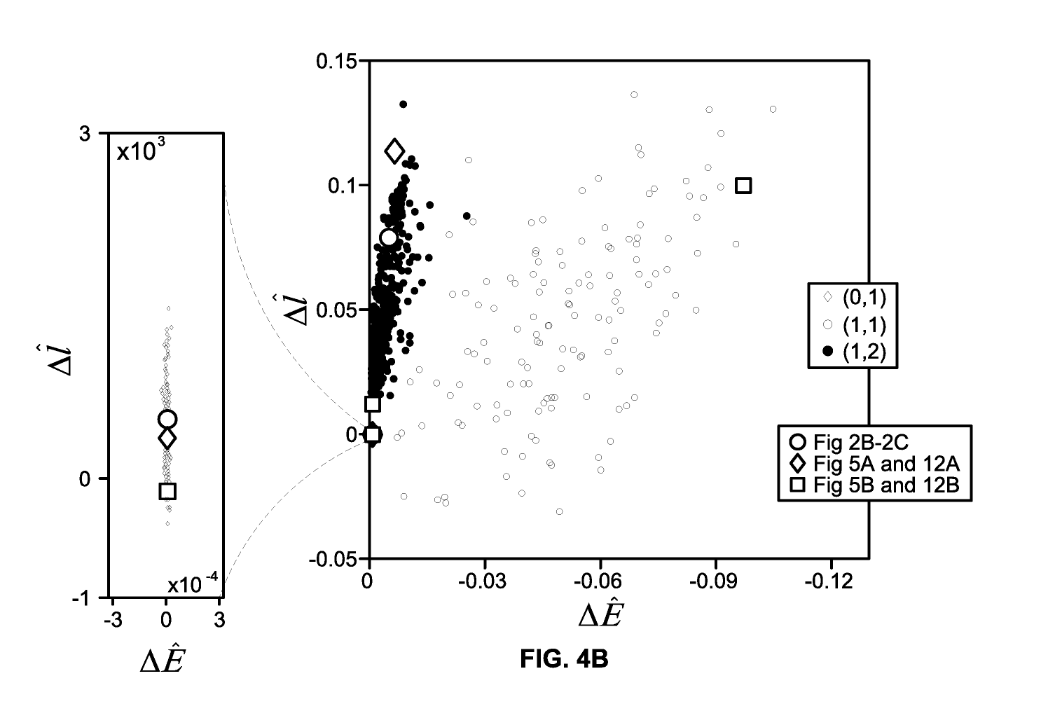

In FIG. 4 Δ\tilde{v}, \tilde{l}, and \tilde{p} are reported versus the normalized change in energy, Δ\tilde{E}, for all transitions that occur in the 630 multi-segment fluidic actuators comprising n=2 segments. Note that there are more than 630 data points, because all actuators show two or more state transitions. It was found that 0.1<Δ\tilde{E}<4·10⁻⁵, indicating that some of the transitions were stable (i.e., Δ\tilde{E}>0), and others were unstable (Δ\tilde{E}<0). It was further found that the energy increase for stable transitions was very small, and was therefore sensitive to the increment size used in the numerical algorithm. By contrast, the elastic energy released during un-stable transitions can be as high as 10% of the stored energy.

Each state transition was characterized according to the changes induced in the individual fluidic actuator segments, and (α, β) used to identify the number of fluidic actuator segments to the right of their pressure peak before (α) and after (β) the state transition. For multi-segment fluidic actuators 200 comprising n=2 segments, the numerical results show three possible types of transitions: (0, 1), in which both segments are initially on the left of their peak in pressure and then one of them crosses its pressure peak during the state transition (small diamond markers in FIGS. 4A-4C); (1, 2), in which the second fluidic actuator segment also crosses its peak in pressure (dark small circular markers in FIGS. 4A-4C); (1, 1), in which both fluidic actuator segments cross their pressure peak, but one while inflating and the other while deflating (small circular markers in FIGS. 4A-4C). It was found that transitions of type (0, 1) occur in all multi-segment fluidic actuators 200 and are always stable. Therefore, the associated changes in elastic energy, length, pressure, and the internal volume distribution are approximately zero. By contrast, transitions of type (1, 1) are always unstable and result in both high elastic energy release (up to 10%) and high internal volume flow (up to 80%). Unlike (1, 1), transitions of type (1, 2) can be either stable or unstable. The unstable transitions resulted in moderate energy release (up to 2.5%), but could lead to significant and instantaneous changes in length (up to 14%). Therefore, the results indicated that not only that snap-through instabilities at constant volume could be triggered in fluidic actuator segments and multi-segment fluidic actuators, but also that the associated released energy could be harnessed to trigger sudden changes in length, drops in pressure, and internal volume flows.

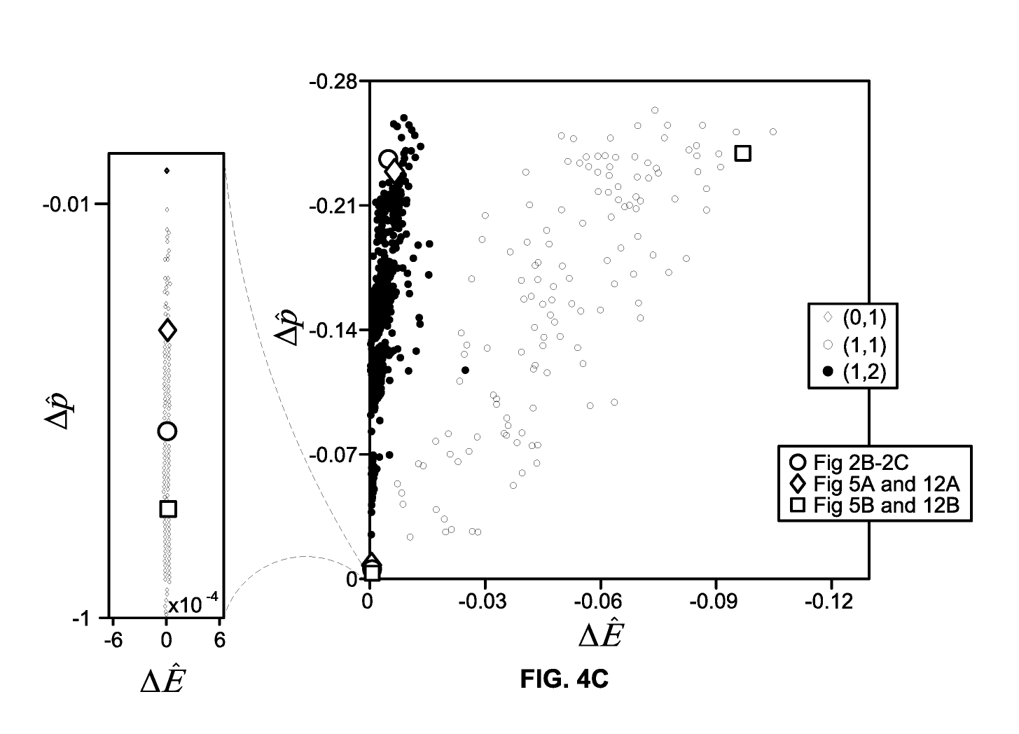

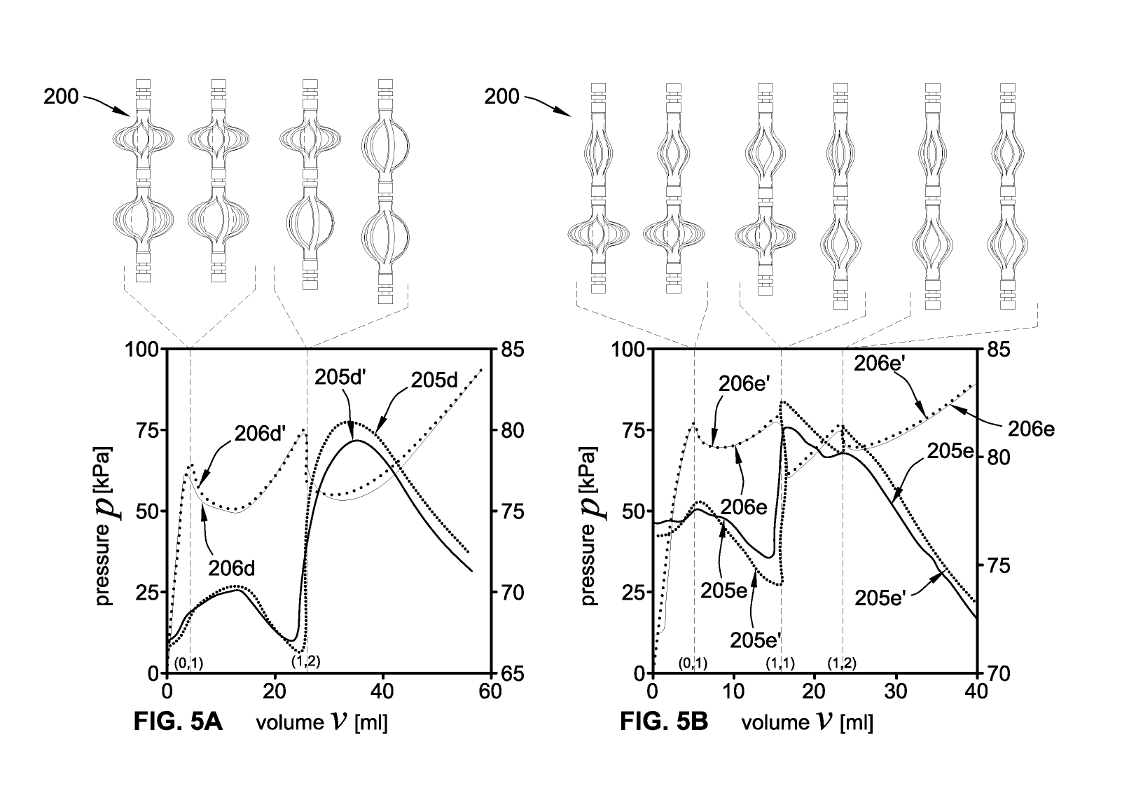

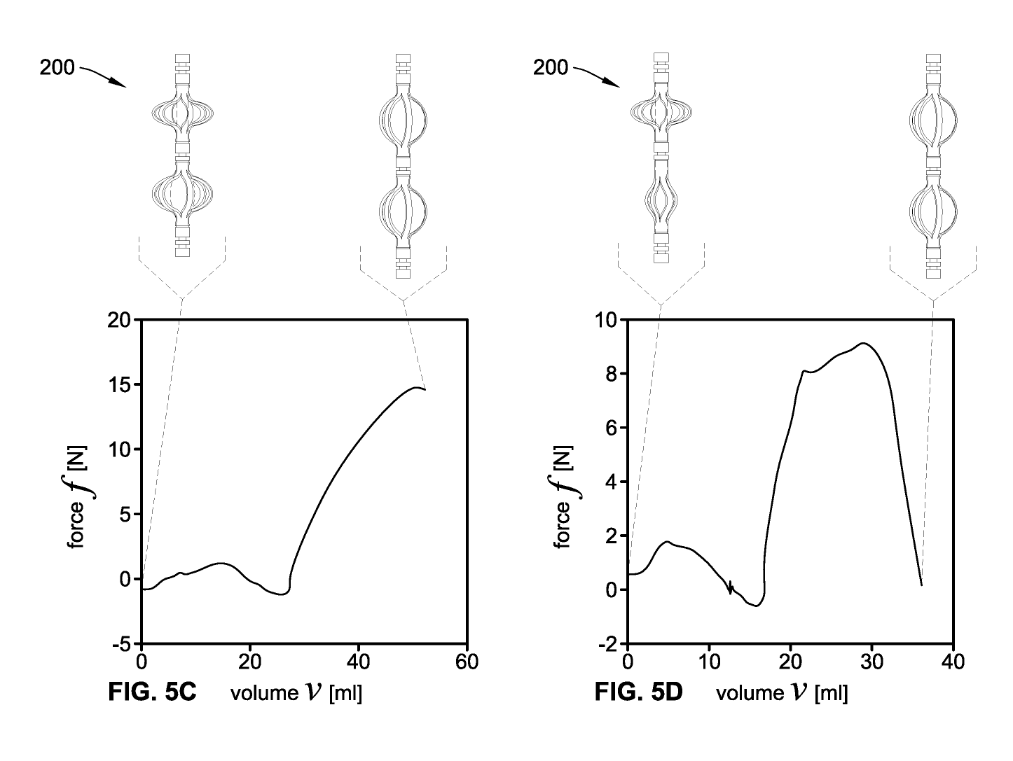

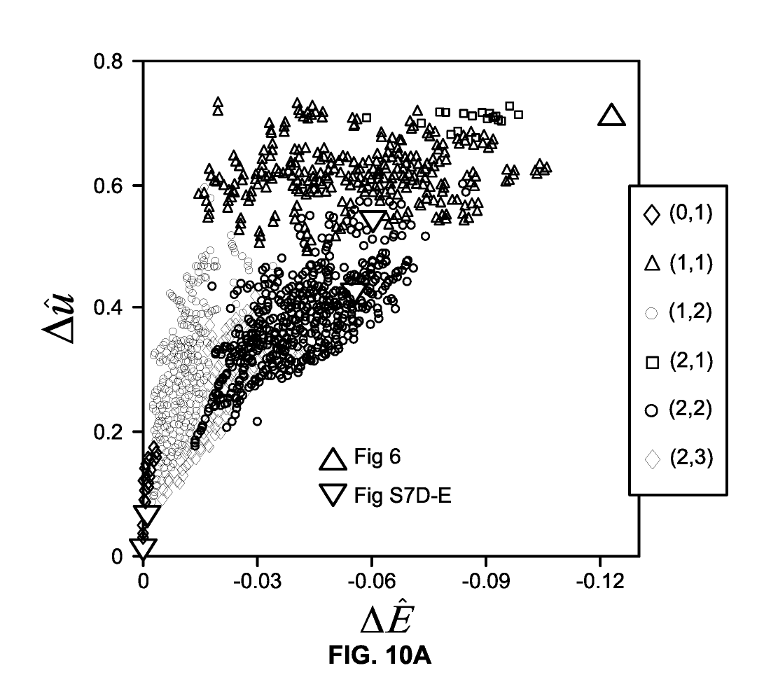

To validate the numerical predictions, above, the inventors measured experimentally the response of several multi-segment fluidic actuators 200. In FIG. 5A are shown the results for the system whose predicted transitions are indicated by the diamond gray markers in FIG. 4. Comparison of the numerically predicted and experimentally observed mechanical response, find an excellent agreement. In particular, for this multi-segment fluidic actuator 200 it is found that the pressure-volume curve is characterized by two peaks, indicating that two transitions take place upon inflation. Although the (0, 1) transition is stable, the (1, 2) transition is unstable and results in an instantaneous and significant increase in length of 11% and a high pressure drop of 23% (see FIG. 5A). This unstable transition is also accompanied by a moderate internal volume redistribution of 22%, resulting in the sudden inflation of the top actuator (see depictions in FIG. 5A and numerical result in FIG. 9A, which shows a relation between the individual volumes of the segments (fluidic actuator segments 100a, 100b, such as shown in FIGS. 2A-2B for a multi-segment fluidic actuator 200 (n=2) with (L_{braid}, L_{tube})=(48, 30) and (50, 20) mm).

FIG. 5B shows the results for the multi-segment fluidic actuator 200 whose response is indicated by the large square markers in FIGS. 4A-4C. Analysis indicates that one stable (0, 1) transition and two unstable transitions are triggered during its inflation. The first snap-through instability is a (1, 1) transition and is accompanied by a significant and sudden volume redistribution (see depictions in upper portion of FIG. 5B and numerical result in FIG. 9B, which shows a relation between the individual volumes of the segments for a multi-segment fluidic actuator 200 (n=2) with (L_{braid}, L_{tube})=(44, 30) and (48, 26) mm) and a large increase in length. The second instability is a (1, 2) transition and results in smaller values for Δ\tilde{l} and Δ\tilde{v}. Again, an excellent agreement is observed between experimental and numerical results, indicating that the modeling approach utilized is accurate and can be used to effectively design fluidic actuators (both single segment and multi-segment) that harness instabilities to amplify their response.

Although the results reported in FIGS. 5A-5B are for multi-segment fluidic actuators 200 that are free to expand, these systems can also be used to exert large forces while supplying only small volumes. To this end, FIGS. 5C-5D show the force measured during inflation when the elongation of the multi-segment fluidic actuator 200 is completely constrained. It was found that in this case also an instability is triggered, resulting in a sudden, large increase in the exerted force. Note that the volume at which the instability occurs is slightly different from that found in the case of free inflation. This discrepancy arises from the fact that the pressure-volume relation of each fluidic actuator segment 100 is affected by the conditions at its boundaries.

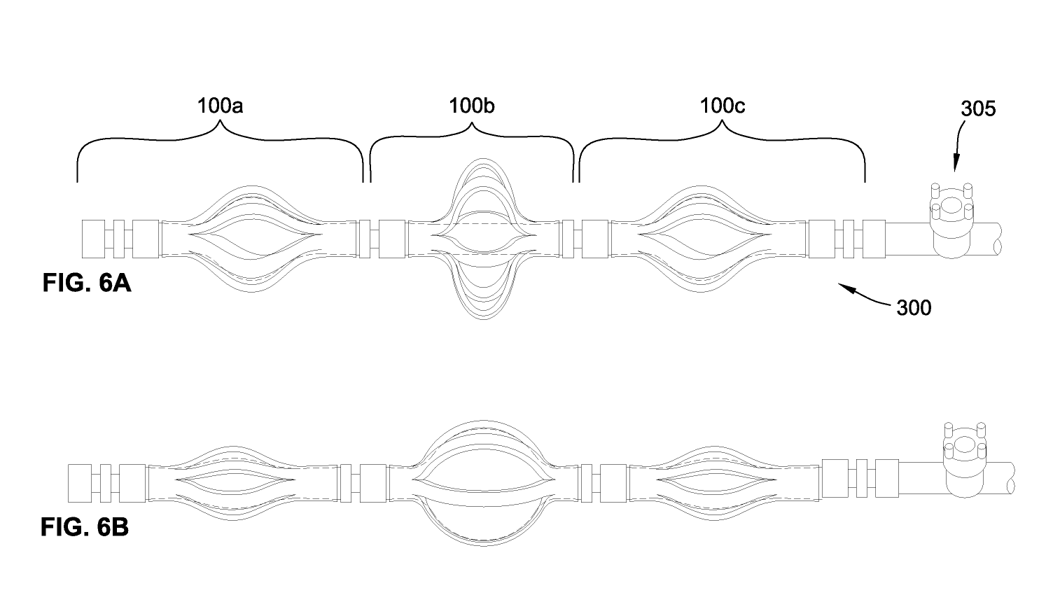

The proposed approach can be easily extended to study more complex multi-segment fluidic actuators comprising a larger number of fluidic actuator segments 100. By increasing n, new types of state transitions can be triggered. For example, transitions of type (2,1) are also observed for n=3 (see FIG. 10A-10C), in which two fluidic actuator segments deflate into a single one, causing all three fluidic actuator segments to cross their peak in pressure. In FIGS. 10A-10C are shown Δ\tilde{v}, Δ\tilde{l} and Δ\tilde{p} versus the normalized change in energy Δ\tilde{E} for all state transitions that occur in 7,140 multi-segment fluidic actuators 200 comprising n=3 fluidic actuator segments 100, with dark diamond, triangle, light circle, square, dark circle and light diamond markers corresponding respectively to (0, 1), (1, 1), (1, 2), (2, 1), (2, 2), and (2, 3) transitions. FIG. 10D shows experimental (solid line) and numerical (dashed line) evolution of pressure and length as a function of the supplied volume for a multi-segment fluidic actuator 200 with n=3, characterized by (L_{braid}, L_{tube})=(40, 28), (44, 22), and (48, 26) mm. FIG. 10E shows a numerically determined relation between the individual volumes of the three fluidic actuator segments 100 (e.g., segments 100a, 100b, 100c as shown in FIG. 6A).

FIGS. 6A-6B relate to a multi-segment fluidic actuator 300 comprising three fluidic actuator segments 100a-100c characterized, respectively, by (L_{braid}, L_{tube})=(40, 28), (44, 30), and (50, 24) mm. The connector 305 connects the multi-segment fluidic actuator 300 to a syringe pump (not shown) configured to inflate the multi-segment fluidic actuator. This multi-segment fluidic actuator 300 underwent an unstable (2,1) transition at v=29 mL. FIGS. 6A-6B show amplification of the response of the multi-segment fluidic actuator 300, where the multi-segment fluidic actuator was inflated v=28 mL, decoupled from the syringe pump (not shown) used to input the 28 mL of water, and then connected to a small reservoir containing only 1 mL of water. By adding only 1 mL of water to the system, a significant internal volume flow of ˜20 mL was able to be triggered resulting in the deflation of two segments (100a, 100c) into one segment (100b), as shown in FIG. 6B. These results further highlight that snap-through instability can be harnessed to amplify the effect of small inputs.

In accord with the experimental and numerical tools discussed above and herein, it has been shown that snap-through instabilities at constant volume can be triggered when multiple fluidic actuator segments 200 with a highly nonlinear pressure-volume relation are interconnected, and that such unstable transitions can be exploited to amplify the response of the system. In stark contrast to most of the soft fluidic actuators previously studied, the present inventors have demonstrated that by harnessing snap-through instabilities it is possible to design and construct systems in which small amounts of fluid suffice to trigger instantaneous and significant changes in pressure, length, shape, and exerted force.

To simplify the analysis, this study utilized water to actuate the segments (due to its incompressibility). However, it is important to note that the actuation speed of the proposed actuators can be greatly increased by utilizing air, or other gas, as the operative fluid. In fact, it was found that water introduces significant inertia during inflation, limiting the actuation speed. In the experiments conducted, it typically took more than one second for the changes in length, pressure, and internal volume induced by the instability to fully take place. However, by simply using air to actuate the system and by adding a small reservoir (e.g., reservoir 400 in FIG. 11F, a fluid-filled line at a positive pressure, etc.) to increase the energy stored in the system, the actuation time can be significantly reduced (from Δt=1.4 s to 0.1 s for the multi-segment fluidic actuator labeled “Air Additional Reservoir” in FIG. 11F), highlighting the potential of these systems for applications where speed is important. Although this actuation time is similar to that of recently reported high-speed soft actuators, only a small volume of supplied fluid is required to actuate the system because the present concepts exploit snap-through instabilities at constant volume. As a result, small compressors (or other conventional actuators) are sufficient to cause on or more predetermined state changes (e.g., inflate) these actuators, making them highly suitable for untethered applications.

The results presented herein indicate that, by combining fluidic actuator segments 100 with designed nonlinear responses and by embracing their nonlinearities, actuators capable of large motion, high forces, and fast actuation at constant volume can be constructed. Although the focus here was specifically on controlling the nonlinear response of fluidic actuators, the analyses herein can also be used to enhance the response of other types of actuators (e.g., thermal, electrical and mechanical) by rationally introducing strong nonlinearities. The approaches disclosed herein therefore enable the design of a class of nonlinear systems.

All individual soft fluidic actuator segments 100 and multi-segment fluidic actuators 200 investigated in the study were tested using a syringe pump (Standard Infuse/Withdraw PHD Ultra; Harvard Apparatus) equipped with two 50-mL syringes with an accuracy of ±0.1% (1000 series, Hamilton Company). The fluidic actuator segments 100 and the multi-segment fluidic actuators 200 were inflated at a rate of 60 and 20 mL/min, respectively, ensuring quasi-static conditions. Moreover, during inflation the pressure was measured using a silicon pressure sensor (MPX5100; Freescale Semiconductor) with a range of 0-100 kPa and an accuracy of ±2.5%, which is connected to a data acquisition system (NI USB-6009, National Instruments). The elongation of the fluidic actuator segments 100 was monitored by putting two markers on both ends of each actuator, and recording their position every two seconds with a high-resolution camera (D90 SLR, Nikon). The length of the fluidic actuator segments 100 were then calculated from the pictures using a digital image processing code in Matlab. Each experiment was repeated 5 times, and the final response of the fluidic actuator segment 100 was determined by averaging the results of the last four tests. Finally, the force exerted by the fluidic actuator segments 100 during inflation were measured when their elongation was completely constrained. In this case a uniaxial materials testing machine (model 5544A; Instron, Inc.) with a 100-N load cell was used to measure the reaction force during inflation.

FIGS. 11A-11F shows actuation time for a multi-segment fluidic actuator 200 consisting of a plurality of interconnected fluidic actuator segments, in this instance characterized by (L_{braid}, L_{tube})=(44, 30) and (48, 26) mm. In the uppermost pair of renderings, the multi-segment fluidic actuator 200 was first inflated to v=16 mL, then decoupled from the syringe pump and connected to a small bulb 405 configured to introduce only 1 mL of water (e.g., by application of external pressure to the bulb to displace the fluid therein). When the 1 mL bolus was input into the system from the bulb 405, it took more than one second (1.4 seconds) for the changes in length, pressure, and internal volume induced by the instability to fully take place. In the middle pair of renderings, the multi-segment fluidic actuator 200 was first inflated by air to v=16 mL, then decoupled from the syringe pump and connected to a small bulb 405 configured to introduce only 1 mL of air. When the 1 mL bolus of air was input into the system from the bulb 405, the time for the changes in length, pressure, and internal volume induced by the instability to fully take place was markedly reduced from 1.4 s (water) to 300 ms.

Yet further, in the lower pair of renderings, the multi-segment fluidic actuator 200 was first inflated by air to v=16 mL, then decoupled from the syringe pump and connected to a small bulb 405 configured to introduce only 1 mL of air. An air reservoir 400 was also added to increase the energy stored in the system. When the 1 mL bolus of air was input into the system from the bulb 405, the time for the changes in length, pressure, and internal volume induced by the instability to fully take place (e.g., actuation time) was further reduced from 300 ms to 100 ms.

Therefore, this simple analytical model indicates that, by enclosing inflatable tubes with stiffer and longer braids, fluidic actuator segments with the desired nonlinear response can be realized. Importantly, it was discovered that, by changing L_{braid} and L_{tube}, their pressure-volume response (i.e., height of the initial pressure peak, softening response, and volume at which the final steep increase in pressure occurs) can be tuned and controlled. Therefore, in accord with the present concepts and the disclosure herein, rationally interconnecting these braided fluidic actuator segments permits design of systems in which snap-through instabilities at constant volume can be selectively triggered.

As noted above, the present concepts include interconnection of any number of fluidic actuator segments 100 (i.e., 100a, . . . 100n, where n is any integer) to form a multi-segment fluidic actuator (e.g., 200 in FIG. 2C, 300 in FIGS. 7A-7D, etc.) tailored to provide a specific response to a specific input. Additionally, any number of such multi-segment fluidic actuators (e.g., 200a, 200b, 200c, . . . 200n, where n is any integer) may be arranged in parallel, in an array, or in another spatial construct (e.g., a helical shape, a biomimetic device, etc.) to provide a tailored response along a selected line of action, within a selected area, or within a selected volume or space. Each of the multi-segment fluidic actuators (e.g., 200a, 200b, . . . 200n) in such a construct may comprise any number of actuator segments that are the same, or are different. For example, along a multi-segment fluidic actuator, each fluidic actuator segment tube 120, braid 150, and connectors 110, 130, may advantageously be specifically tailored to achieve a specific local and/or global function within the multi-segment fluidic actuator, or even as to other connected multi-segment fluidic actuators. The connectors 110, 130 noted herein (e.g., Luer connectors) may comprise male and/or female connection elements, and may optionally comprise a stopcock or valve (e.g., a check valve) to regulate and/or stop flow.

In the examples provided above, for purposes of the experiments and convenience, a syringe pump was used to input fluid into the fluidic actuator(s). In practical applications, particularly in untethered systems, other forms of pumps or actuators may be advantageously utilized to facilitate the small fluid flows required in the presently described systems to utilize (i.e., selectively trigger) the snap-through instabilities to achieve the desired change(s) in state.

In at least some aspects, one or more controllers are utilized to govern fluid flow to one or more single-segment fluidic actuator(s) 100 and/or multi-segment fluidic actuator(s) 200, such as by controlling activation of one or more pumps, one or more actuators, and/or one or more actuatable valves governing fluid flow to the fluidic actuator(s), to thereby initiate actuation of the fluidic actuator(s). Responsive to this initiation of actuation of the fluidic actuator(s), the configured instabilities of the respective single-segment and/or multi-segment fluidic actuator(s) then control the response of the actuator(s). Accordingly, such controller(s) may be optionally utilized to prompt a desired state change(s) in the fluidic actuator(s) (e.g., 100, 200) to thereby achieve, via the predetermined response(s) of the fluidic actuator(s), a corresponding change in state in a system utilizing the fluidic actuator(s).

It is to be noted that the modeling disclosed herein predicts only qualitatively and not quantitatively the response of the segments, mainly due to the effect of boundary conditions (i.e., the deformation is not uniform throughout the membrane) and inextensibility of the braids. For example, local instabilities resulting in bulges are triggered during the inflation of tubes. While such effects can be accounted for in further analyses, the modeling disclosed herein is eminently intuitive.

The foregoing disclosure has been presented for purposes of illustration and description. The foregoing description is not intended to limit the present concepts to the forms, features, configurations, modules, or applications described herein by way of example. Other non-enumerated configurations, combinations, and/or sub-combinations of such forms, features, configurations, modules, and/or applications are considered to lie within the scope of the disclosed concepts.

1. A fluidic actuator comprising:
at least one fluidic actuator segment comprising an elastic tube having a first initial length and a braid having a second initial length greater than the first initial length disposed, in a buckled state, about the elastic tube and imparting an axial force to the elastic tube.

2. The fluidic actuator according to claim 1, wherein a stiffness of the braid is higher than a stiffness of the elastic tube.

3. The fluidic actuator according to claim 2, further comprising:
a plurality of fluidic actuator segments, each of the fluidic actuator segments comprising an elastic tube having a first initial length and a braid having a second initial length greater than the first initial length disposed, in a buckled state, about the elastic tube and imparting an axial force to the elastic tube.

4. The fluidic actuator according to claim 3, wherein the plurality of fluidic actuator segments are disposed serially and are connected to one another via connector elements.

5. The fluidic actuator according to claim 3, wherein at least one of the plurality of fluidic actuator segments is different from at least one other one of the plurality of fluidic actuator segments.

6. The fluidic actuator according to claim 3,
wherein a first fluidic actuator segment comprises an elastic tube having a first physical characteristic selected from at least one of a material, a shear modulus, a first initial length, a radius or a thickness, and
wherein a second fluidic actuator segment comprises an elastic tube having a second physical characteristic selected from at least one of a material, a shear modulus, a first initial length, a radius or a thickness, and
wherein the first physical characteristic of the first fluidic actuator segment is different than a corresponding second physical characteristic of the second fluidic actuator segment.

7. The fluidic actuator according to claim 6,
wherein a first fluidic actuator segment comprises a braid having a first physical characteristic selected from at least one of a material, a stiffness, a first initial length, an inner radius, a thickness, or a first volume enclosed by the braid, and
wherein a second fluidic actuator segment comprises a braid having a second physical characteristic selected from at least one of a material, a stiffness, a first initial length, an inner radius, a thickness, or a first volume enclosed by the braid, and
wherein the first physical characteristic of the first fluidic actuator segment is different than a corresponding second physical characteristic of the second fluidic actuator segment.

8. The fluidic actuator according to claim 1, further comprising:
a fluid reservoir communicatively connected to the at least one fluidic actuator segment.

9. The fluidic actuator according to claim 1, further comprising:
one or more pumps or actuators communicatively connected to the at least one fluidic actuator segment and configured to selectively introduce a metered volume of fluid into the fluidic actuator.

10. The fluidic actuator according to claim 1, wherein an operative fluid used in the fluidic actuator is a gas.

11. The fluidic actuator according to claim 1, wherein an operative fluid used in the fluidic actuator is a liquid.

12. A method of making a fluidic actuator comprising:
selecting a plurality of fluidic actuator segments, each of the plurality of fluidic actuator segments comprising an elastic tube having a first initial length and a braid having a second initial length greater than the first initial length disposed, in a buckled state, about the elastic tube and imparting an axial force to the elastic tube,
interconnecting the plurality of fluidic actuator segments to allow fluid flow therebetween,
wherein the act of selecting comprises selecting the plurality of fluidic actuator segments to trigger one or more snap-through instabilities responsive to predetermined volumetric fluid inputs to release energy and trigger at least substantially instantaneous changes in at least one of internal pressure, extension, shape, and exerted force.

13. The method of making a fluidic actuator comprising according to claim 12, further comprising the act of:
connecting a fluid reservoir to the plurality of fluidic actuator segments.

14. The method of making a fluidic actuator comprising according to claim 13, further comprising the act of:
connecting one or more pumps or actuators to the plurality of fluidic actuator segments, the one or more pumps or actuators being configured to selectively introduce a metered volume of fluid into the fluidic actuator.

15. The method of making a fluidic actuator comprising according to claim 13, wherein the plurality of fluidic actuator segments are disposed serially and are connected to one another via connector elements.

16. The method of making a fluidic actuator comprising according to claim 15, wherein at least one of the plurality of fluidic actuator segments is different from at least one other one of the plurality of fluidic actuator segments.

17. A fluidic actuator system comprising:
at least one fluidic actuator comprising at least one fluidic actuator segment, the at least one fluidic actuator segment comprising an elastic tube having a first initial length and a braid having a second initial length greater than the first initial length disposed, in a buckled state, about the elastic tube and imparting an axial force to the elastic tube;
a fluid reservoir;
a valve disposed in a fluid pathway between the fluid reservoir and the at least one fluidic actuator; and
a controller configured to actuate the valve to effectuate an introduction of a pre-determined volume of a fluid from the fluid reservoir into the at least one fluidic actuator to effect a state change in the at least one fluidic actuator from a first state to a second state or to effectuate a discharge of a pre-determined volume of a fluid from the at least one fluidic actuator to effect a state change in the at least one fluidic actuator from a second state to a first state.

18. The fluidic actuator system according to claim 17, wherein a stiffness of the braid is higher than a stiffness of the elastic tube.

19. The fluidic actuator system according to claim 18, wherein the at least one fluidic actuator comprises a plurality of fluidic actuator segments, each of the fluidic actuator segments comprising an elastic tube having a first initial length and a braid having a second initial length greater than the first initial length disposed, in a buckled state, about the elastic tube and imparting an axial force to the elastic tube.

20. The fluidic actuator system according to claim 19,
wherein a first fluidic actuator segment comprises an elastic tube having a first physical characteristic selected from at least one of a material, a shear modulus, a first initial length, a radius or a thickness, and
wherein a second fluidic actuator segment comprises an elastic tube having a second physical characteristic selected from at least one of a material, a shear modulus, a first initial length, a radius or a thickness, and
wherein the first physical characteristic of the first fluidic actuator segment is different than a corresponding second physical characteristic of the second fluidic actuator segment.
